(19) United States
(12) Patent Application Publication
(10) Pub. No.: US 2021/0374840 A1
(43) Pub. Date: Dec. 2, 2021

(54) COMPUTER READABLE RECORDING MEDIUM, SETTLEMENT SYSTEM, AND SETTLEMENT SERVER

(71) Applicant: TOYOTA JIDOSHA KABUSHIKI KAISHA, Toyota-shi (JP)

(72) Inventors: Tomokazu MAYA, Nagoya-shi (JP); Naoki YAMAMURO, Nagoya-shi (JP); Yuki NAKATANI, Tokyo-to (JP); Kosuke MIYAKE, Tokyo-to (JP); Soushi MIZUNO, Tokyo-to (JP); Yasushi FURUHATA, Kodaira-shi (JP); Masataka NARITA, Tokyo-to (JP); Yasuhiro TAKEHARA, Nagoya-shi (JP)

(73) Assignee: TOYOTA JIDOSHA KABUSHIKI KAISHA, Toyota-shi (JP)

(21) Appl. No.: 17/239,741

(22) Filed: Apr. 26, 2021

(30) Foreign Application Priority Data
May 29, 2020 (JP) 2020-094764

(51) Int. Cl. G06Q 30/06; G06Q 30/02; G06Q 20/06; G06Q 50/30

(52) U.S. Cl. CPC G06Q 30/0645; G06Q 50/30; G06Q 20/06; G06Q 30/0284

(57) ABSTRACT

Provided is a non-transitory computer-readable recording medium on which an executable program is recorded, the program causing a processor of a computer to execute outputting, to a display, information obtained by comparing a charge related to extension of car sharing that provides a rental vehicle with a balance of electronic money registered as a settlement method of the car sharing.

The present application claims priority to and incorporates by reference the entire contents of Japanese Patent Application No. 2020-094764 filed in Japan on May 29, 2020.

### BACKGROUND

The present disclosure relates to a computer readable recording medium, a settlement system, and a settlement server.

JP 2019-139452 A discloses a technique used in car sharing using electronic money, in which a difference amount is collected when the balance of electronic money is less than the usage amount. According to this technique, car sharing may be used even when the balance of electronic money is insufficient.

### SUMMARY

There is a need for enhanced convenience of electronic money used for utilizing car sharing.

According to one aspect of the present disclosure, there is provided a non-transitory computer-readable recording medium on which an executable program is recorded, the program causing a processor of a computer to execute outputting, to a display, information obtained by comparing a charge related to extension of car sharing that provides a rental vehicle with a balance of electronic money registered as a settlement method of the car sharing.

### BRIEF DESCRIPTION OF THE DRAWINGS

FIG. 1 is a diagram schematically illustrating a configuration of a car sharing system including a settlement server according to an embodiment;

FIG. 2 is a block diagram illustrating details of individual components of a car sharing system including a settlement server according to the embodiment;

FIG. 3 is a diagram schematically illustrating a relationship between car sharing and a settlement method in a car sharing system including a settlement server according to the embodiment;

FIG. 4 is a diagram illustrating an example in which an extension selection screen is displayed on an operation/display unit of a user terminal in a settlement server according to the embodiment;

FIG. 5 is a diagram illustrating an example in which a warning display screen is displayed on an operation/display unit of a user terminal in a settlement server according to the embodiment;

FIG. 6 is a diagram illustrating an example in which a warning display screen is displayed on an operation/display unit of a user terminal in a settlement server according to the embodiment;

FIG. 7 is a diagram illustrating an example in which a warning display screen is displayed on an operation/display unit of a user terminal in a settlement server according to the embodiment;

FIG. 8 is a diagram illustrating an example in which a warning display screen is displayed on an operation/display unit of a user terminal in a settlement server according to the embodiment; and

FIG. 9 is a diagram illustrating an example in which a warning display screen is displayed on an operation/display unit of a user terminal in a settlement server according to the embodiment.

### DETAILED DESCRIPTION

A computer readable recording medium storing a settlement program, a settlement system, and a settlement server according to an embodiment of the present disclosure will be described with reference to the drawings. Note that the constituent elements in the following embodiment include those that may be easily replaced by those skilled in the art, or those that are substantially the same.

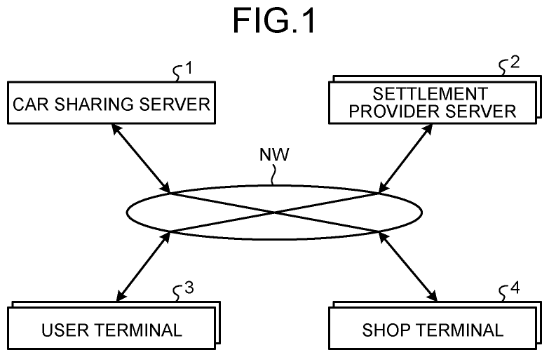

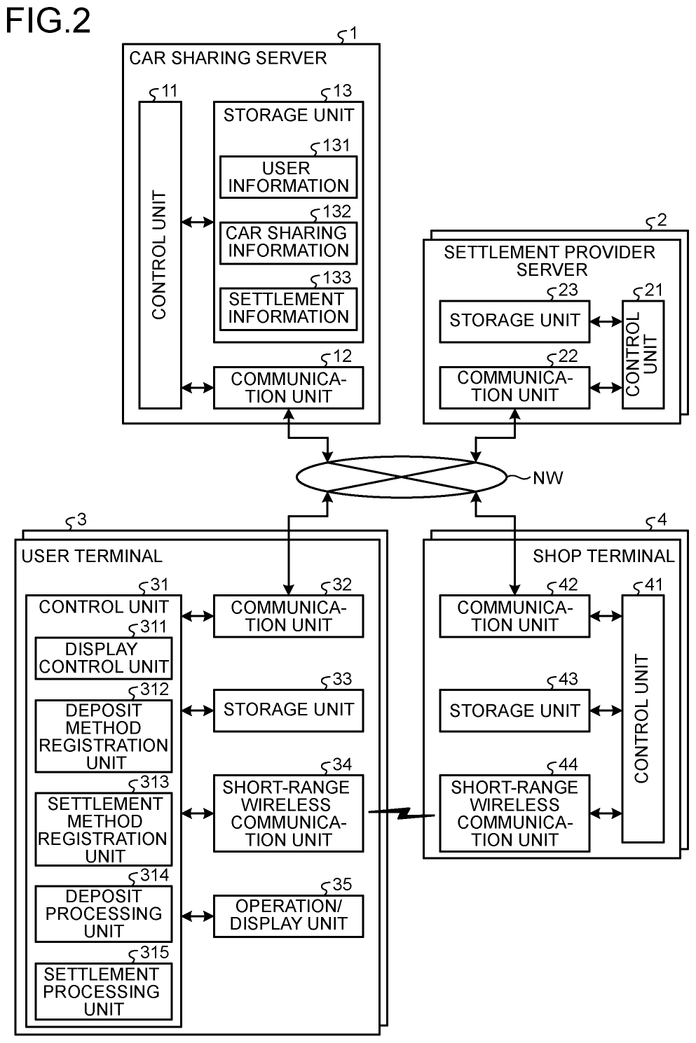

The configuration of a car sharing system that executes the settlement program according to the embodiment will be described with reference to FIGS. 1 and 2. As illustrated in FIG. 1, the car sharing system includes a car sharing server 1, a settlement provider server 2, a user terminal 3, and a shop terminal 4.

The car sharing server 1, the settlement provider server 2, the user terminal 3, and the shop terminal 4 are communicable with each other through a network NW. The network NW is composed of, for example, an Internet network, a mobile phone network, or the like.

The car sharing server 1 is a settlement server for comprehensively managing a car sharing system in which one settlement method is registered, and is managed by a car sharing system administrator. Alternatively, however, a plurality of settlement methods may be registered in the car sharing server 1. In the car sharing system, the car sharing usage fee is paid by a registered settlement method. The car sharing usage fee may be a fee system in which a distance charge based on the distance (for example, 15 yen per 1 km) and an hourly charge based on the time (for example, 200 yen per 15 minutes) are added up. Alternatively, however, the distance charge or hourly charge alone may be added, or even a fixed amount system independent of distance or time may be used. As illustrated in FIG. 2, the car sharing server 1 includes a control unit (first processor) 11, a communication unit 12, and a storage unit 13.

The control unit 11 is specifically equipped with: a processor including a central processing unit (CPU), a digital signal processor (DSP), and a field-programmable gate array (FPGA); and memory (main storage unit) including random access memory (RAM) and read only memory (ROM).

The control unit 11 loads a program stored in the storage unit 13 into the work area of the main storage unit and executes the program. Through execution of the program, the control unit 11 controls individual components, thereby actualizing a function that matches a predetermined purpose.

The communication unit 12 is constituted with, for example, a local area network (LAN) interface board, a wireless communication circuit for wireless communication, or the like. The communication unit 12 is connected to the network NW such as the Internet which is a public communication network. The communication unit 12 communicates with the settlement provider server 2, the user terminal 3, and the shop terminal 4 by connecting to the network NW.

The storage unit 13 includes a recording medium such as erasable programmable ROM (EPROM), a hard disk drive (HDD), and a removable medium. Examples of the removable medium include disc recording media such as a universal serial bus (USB) flash drive, a compact disc (CD), a digital versatile disc (DVD), and a Blu-ray (BD; registered trademark). The storage unit 13 may store an operating system (OS), various programs, various tables, various databases, or the like. The storage unit 13 according to the embodiment stores user information 131, car sharing information 132, and settlement information 133 for each of users of the car sharing system.

The user information 131 is information related to a user who uses the car sharing system. Examples of the user information 131 include information regarding the user who has registered to use the car sharing system, such as user ID, password, user name, user contact information (for example, street address, telephone number, email address, etc.), information including usage registration history, and registered settlement method, information regarding other settlement methods registered to deposit money to the settlement method, and settlement passcode. The user ID and password among the user information 131 are used for an authentication process such as login to the car sharing server 1.

The car sharing information 132 is car sharing information related to the car sharing system. Examples of car sharing information include a car sharing system pricing plan, available vehicle types, vehicle-specific pricing, or the like.

The settlement information 133 is information related to the settlement of the car sharing system. Examples of the settlement information 133 include user ID, a settlement method used for settlement (for example, electronic money payment (non-contact settlement), scan payment, code payment, etc.), and the settlement history.

The settlement provider server 2 is a server for managing the settlement method registered in the car sharing system, and manages a settlement method using electronic money, for example. The settlement provider server 2 includes a control unit 21, a communication unit 22, and a storage unit 23. The control unit 21, the communication unit 22, and the storage unit 23 are physically similar to the control unit 11, the communication unit 12, and the storage unit 13, respectively.

The storage unit 23 stores information related to the settlement method for each of users of the car sharing system. Examples of the information related to the settlement method include the user's name, the balance of electronic money, the account number of the electronic money deposit account, the credit card number for the electronic money deposit, the electronic money deposit/withdrawal history, or the like.

The user terminal 3 is a computer terminal used by the user. Examples of the user terminal 3 include a car navigator of the vehicle rented by the user, and a smartphone owned by the user, but may be mobile phones, tablet terminals, wearable computers, personal computers, or the like. The user terminal 3 may be any terminal as long as it may exchange information with the car sharing server 1.

The user terminal 3 includes a control unit (second processor) 31, a communication unit 32, a storage unit 33, a short-range wireless communication unit 34, and an operation/display unit (display) 35. The control unit 31, the communication unit 32, and the storage unit 33 are physically similar to the control unit 11, the communication unit 12, and the storage unit 13, respectively. Through execution of the program, the control unit 31 functions as a display control unit 311, a deposit method registration unit 312, a settlement method registration unit 313, a deposit processing unit 314, and a settlement processing unit 315.

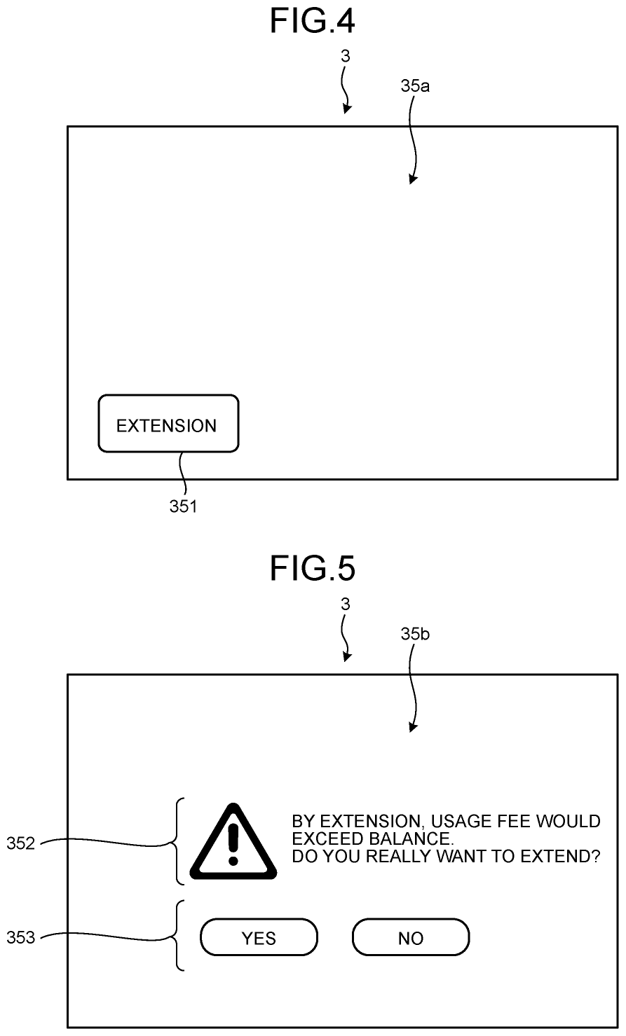

The display control unit 311 controls the content to be displayed on the operation/display unit 35. Based on the user's operation (touch operation, flick operation, or the like), the display control unit 311 displays on the operation/display unit 35, a login screen used at the time of logging in to the car sharing system, a deposit screen used at the time of depositing to the car sharing electronic money, an extension selection screen 35a (refer to FIG. 4) for selecting usage extension of car sharing, and a warning display screen 35b and warning display screen 35c (refer to FIGS. 5 to 9) for displaying warning messages. In addition, the display control unit 311 causes each of screens to transition based on a user's operation.

The deposit method registration unit 312 registers a deposit method for depositing to the electronic money. Specifically, the deposit method registration unit 312 transmits, to the car sharing server 1, a deposit method registration request for asking for the registration of a plurality of different settlement methods (for example, a bank account, a credit card, etc.) operated by a plurality of providers as a method for depositing to the electronic money. Having received the deposit method registration request from the deposit method registration unit 312, the car sharing server 1 stores the settlement method included in the deposit method registration request onto the storage unit 13, thereby registering the method as the deposit method. Furthermore, the car sharing server 1 transmits the settlement method included in the deposit method registration request to the settlement provider server 2. Having received the deposit method registration request from the car sharing server 1, the settlement provider server 2 stores the settlement method included in the deposit method registration request onto the storage unit 23, thereby registering the method as the deposit method.

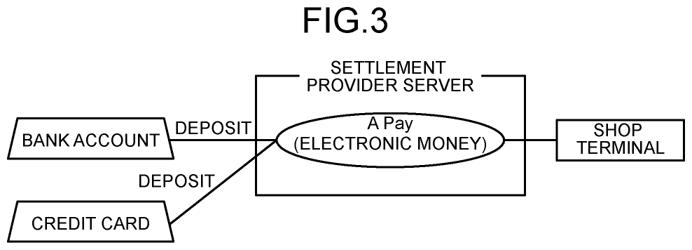

Here, FIG. 3 is a diagram schematically illustrating a relationship between settlement methods in a settlement system. The “settlement method” indicates a payment source (funding source) used at the time of making a settlement, and here, mainly indicates prepaid-system electronic money to be deposited in advance, as the settlement method. This settlement method is associated with a deposit method such as a bank account, a credit card, or the like, being a method for depositing to electronic money, and capable of depositing to the electronic money. However, when the settlement method is a prepaid system in which deposit is made in advance by cash or the like, the electronic money does not have to be associated with the deposit method such as a bank account or a credit card.

By using this settlement method, settlement is performed between the user terminal 3 and the shop terminal 4. Specifically, by holding the user terminal 3 over the shop terminal 4, various settlement methods are executed between the short-range wireless communication unit 34 of the user terminal 3 and a short-range wireless communication unit 44 of the shop terminal 4, including the settlement that is made in a non-contact manner, the settlement that is made by reading a barcode or QR code (registered trademark) displayed on the shop terminal 4 with a camera of the user terminal 3 or the like, or the settlement that is made by reading a barcode or QR code (registered trademark) displayed on the user terminal 3 with a code reader of the shop terminal 4 or the like.

The settlement method registration unit 313 registers various settlement methods. The settlement method registration unit 313 transmits a settlement method registration request for registering the settlement method, to the car sharing server 1. Having received the settlement method registration request from the settlement method registration unit 313, the control unit 11 of the car sharing server 1 stores the settlement method included in the settlement method registration request, onto the storage unit 13 as user information 131, thereby performing registration of this method as the settlement method.

The deposit processing unit 314 deposits the money to the car sharing electronic money. Specifically, the deposit processing unit 314 transmits a deposit request for depositing to electronic money, to the car sharing server 1 by a settlement method registered as a deposit method. Having received the deposit request from the deposit processing unit 314, the car sharing server 1 increases the balance of electronic money based on the deposit amount information included in the deposit request. That is, the car sharing server 1 updates the balance of the electronic money stored in the storage unit 13 in accordance with the increase amount in the balance of the electronic money. Furthermore, the car sharing server 1 transmits the deposit request to the settlement provider server 2. Having received the deposit request from the car sharing server 1, the settlement provider server 2 updates the balance of electronic money stored in the storage unit 23 in accordance with the increase amount in the balance of electronic money based on the deposit amount information included in the deposit request.

The settlement processing unit 315 executes the settlement using the settlement method selected by the user. Specifically, the settlement processing unit 315 transmits a settlement request to the shop terminal 4 through the short-range wireless communication unit 34 as a settlement method. Alternatively, the settlement processing unit 315 may transmit the settlement request to the shop terminal 4 by reading a barcode or a QR code (registered trademark) displayed on the shop terminal 4 with a camera or the like of the user terminal 3 as a settlement method. Further alternatively, the settlement processing unit 315 may transmit the settlement request to the shop terminal 4 by reading a barcode or a QR code (registered trademark) displayed on the user terminal 3 with a code reader or the like of the shop terminal 4 as a settlement method. The settlement request transmitted from the settlement processing unit 315 to the shop terminal 4 may include or need not include information indicating the settlement amount (hereinafter referred to as “settlement amount information”).

Subsequently, regarding the settlement processing unit 315 in the case of settlement by electronic money, a control unit 41 of the shop terminal 4 transmits a settlement request including settlement amount information to the car sharing server 1 via the network NW. Having received the settlement request from the shop terminal 4, the car sharing server 1 decreases the balance of electronic money based on the settlement amount information included in the settlement request. That is, the control unit 11 updates the balance of the electronic money stored in the storage unit 23 in accordance with the decrease amount in the balance of the electronic money. Furthermore, the car sharing server 1 transmits the deposit request to the settlement provider server 2. Based on the deposit amount information included in the deposit request, the settlement provider server 2 updates the balance of the electronic money stored in the storage unit 23 in accordance with the increase amount in the balance of electronic money.

The storage unit 33 stores various screen data to be displayed on the operation/display unit 35 by the display control unit 311. Furthermore, the storage unit 33 temporarily stores user information 131, car sharing information 132, settlement information 133, or the like as necessary.

The short-range wireless communication unit 34 has a communication function conforming to the standards such as near field communication (NFC), Bluetooth (registered trademark) low energy (BLE), and infrared data association (IrDA). For example, when making electronic money settlement, the user terminal 3 performs short-range wireless communication with the shop terminal 4 through the short-range wireless communication unit 34.

The operation/display unit 35 is constituted with a touch panel display, for example, and has an input function of receiving an operation by a user's finger or a pen or the like, and a display function of displaying various types of information under the control of the display control unit 311.

The shop terminal 4 is provided in shops (member stores) where electronic money may be used. However, the shop terminal 4 may be a server that functions as a virtual shop (so-called Electronic Commerce site) opened on the Internet. The shop terminal 4 includes a control unit 41, a communication unit 42, a storage unit 43, and a short-range wireless communication unit 44. The control unit 41, the communication unit 42, the storage unit 43, and the short-range wireless communication unit 44 are physically similar to the control unit 11, the communication unit 12, the storage unit 13, and the short-range wireless communication unit 34.

Hereinafter, the display control performed by the display control unit 311 on the operation/display unit 35 in the car sharing system including the car sharing server 1 according to the present embodiment will be described with reference to FIGS. 4 to 9.

First, it is assumed that a vehicle is rented by a user by using the car sharing system, and the user is operating the user terminal 3 which is a car navigation system mounted on the vehicle. Here, on the extension selection screen 35a illustrated in FIG. 4, the control unit 11 receives an extension request for car sharing via the user terminal 3. Specifically, the control unit 11 receives an extension request input by operation of selecting an extension button 351 by the user. The time to extend the car sharing may be a predetermined time (for example, 30 minutes), but the user may arbitrarily input the time to extend.

Accordingly, the control unit 11 calculates an extension fee, which is calculated based on the input extension request. Specifically, in a case where the time to extend the car sharing is 30 minutes, the control unit 11 multiplies the 30 minutes by the usage fee per unit time to calculate the extension fee.

The control unit 11 subsequently outputs information obtained by comparing the charge related to the extension of car sharing with the balance of the electronic money registered as the settlement method of car sharing, onto the display. Specifically, the control unit 11 compares the calculated extension fee with the balance of electronic money, and outputs a warning message onto the display when the extension fee exceeds the balance. FIG. 5 illustrates an example of a warning display screen 35b displayed on the operation/display unit 35 by the display control unit 311. The figure illustrates an example in which the warning message “By extension, the usage fee would exceed the balance. Do you really want to extend?” is displayed in a warning display region 352 and “Yes” or “No” buttons for receiving the selection of whether to extend the car sharing are displayed in a selection region 353. This results in giving the user the knowledge that the extension fee may not be paid with the balance of the electronic money, making it possible to enhance the convenience of the electronic money as well as facilitate selection of whether to extend the car sharing, leading to further enhancement of the convenience of electronic money.

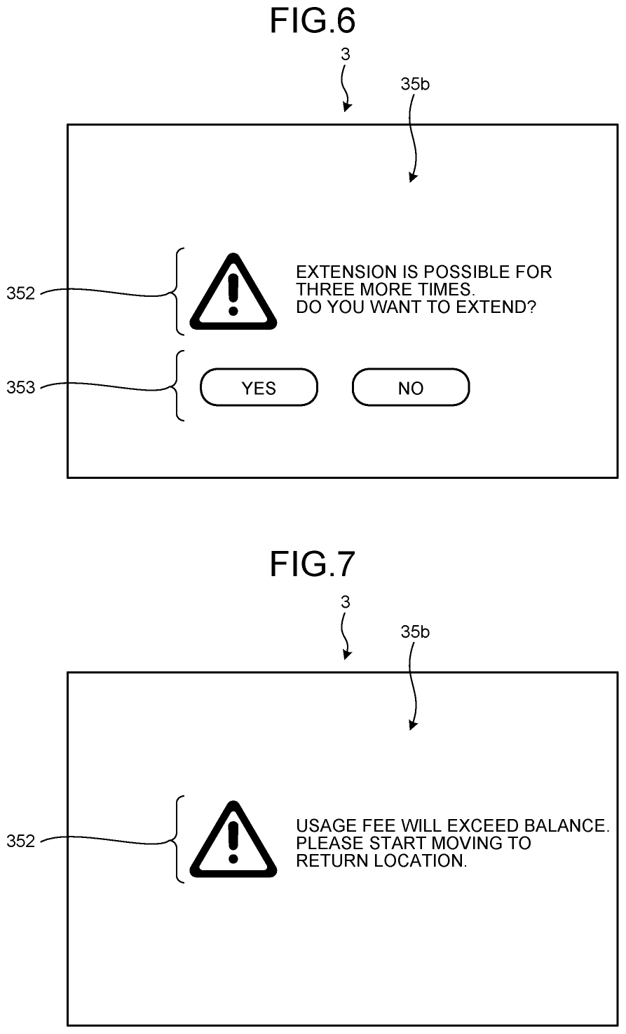

Furthermore, the control unit 11 may calculate the extendable time within a range of the balance. Specifically, the control unit 11 divides the balance of electronic money by the usage fee per unit time to calculate the extendable time within the range of the balance, and displays the calculated time on the operation/display unit 35. Furthermore, in a case where the extension time length obtained by one extension request is predetermined, the control unit 11 may control to display on the operation/display unit 35 how many times the extension may be performed. FIG. 6 illustrates an example of a warning display screen 35b displayed on the operation/display unit 35 by the display control unit 311. The figure illustrates an example in which the warning message “Extension is possible for three more times. Do you want to extend?” is displayed in the warning display region 352 and “Yes” or “No” buttons for receiving the selection of whether to extend the car sharing are displayed in a selection region 353. This results in giving the user the knowledge that the time of extensions that may be performed with the balance of the electronic money, making it possible to enhance the convenience of the electronic money as well as facilitate selection of whether to extend the car sharing, leading to further enhancement of the convenience of electronic money.

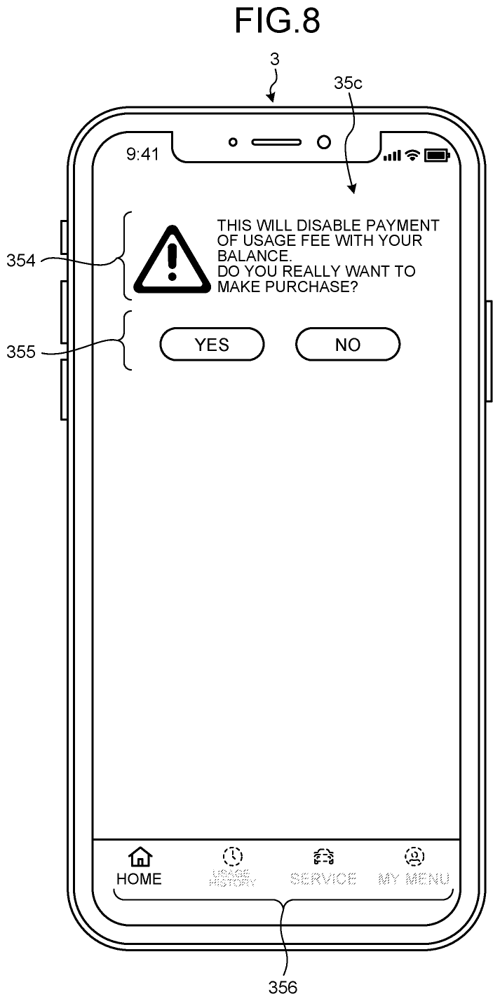

Furthermore, the control unit 11 may determine whether it is possible to return the vehicle within the range of the balance. Specifically, the control unit 11 acquires a distance between the current location and a return location of the vehicle. The control unit 11 may acquire the current location based on the position information of the user terminal 3 measured by reception of signals from the global positioning system (GPS) satellite, or may acquire the current location by the name or address input by the user. The return location of the vehicle is registered in the storage unit 33 in advance. Subsequently, the control unit 11 calculates the time for returning the vehicle based on the distance between the current location and the return location of the vehicle. Furthermore, the control unit 11 calculates the usage fee for the return, which is the sum of the distance charge added based on the distance between the current location and the return location of the vehicle and the time charge added based on the time for the return. The control unit 11 determines whether the calculated usage fee exceeds the balance, thereby determining whether the vehicle may be returned within the range of the balance. When determined that the vehicle may not be returned within the balance, the control unit 11 outputs a warning message to the display. FIG. 7 illustrates an example of a warning display screen 35b displayed on the operation/display unit 35 by the display control unit 311. The figure illustrates an example in which a warning message “Usage fee will exceed the balance. Please start moving to the return location.” is displayed in the warning display region 352. This results in giving the user the knowledge that the usage fee including the fee for moving to the return location will exceed the balance of the electronic money, making it possible to enhance the convenience of the electronic money.

Furthermore, the control unit 11 may receive a settlement request for a predetermined settlement amount accompanying the purchase of a product, and may determine whether the vehicle may be returned within the range of the balance for a case where the settlement of the settlement amount is executed. Specifically, the control unit 11 may determine whether the sum of the settlement amount and the car sharing usage fee will exceed the balance in a case where the settlement of the settlement amount is executed based on the settlement request received by the user terminal 3 from the shop terminal 4, and may then determine whether the vehicle may be returned within the balance. At this time, the control unit 11 may determine whether the vehicle may be returned within the range of the balance in consideration of the usage fee for the return in addition to the settlement amount. FIG. 8 illustrates an example of a warning display screen 35c displayed on the operation/display unit 35 by the display control unit 311 of the user terminal 3 which is a smartphone. The figure illustrates an example in which the warning message “This will disable payment of usage fee with your balance. Do you really want to make the purchase?” is displayed in a warning display region 354 and “Yes” or “No” buttons for receiving the selection of whether to extend the car sharing is displayed in a selection region 355.This results in giving the user the knowledge that the car sharing usage fee may not be paid with the balance of the electronic money when the product with a predetermined settlement amount is purchased, making it possible to facilitate selection of whether to purchase the product, leading to enhancement of the convenience of electronic money.

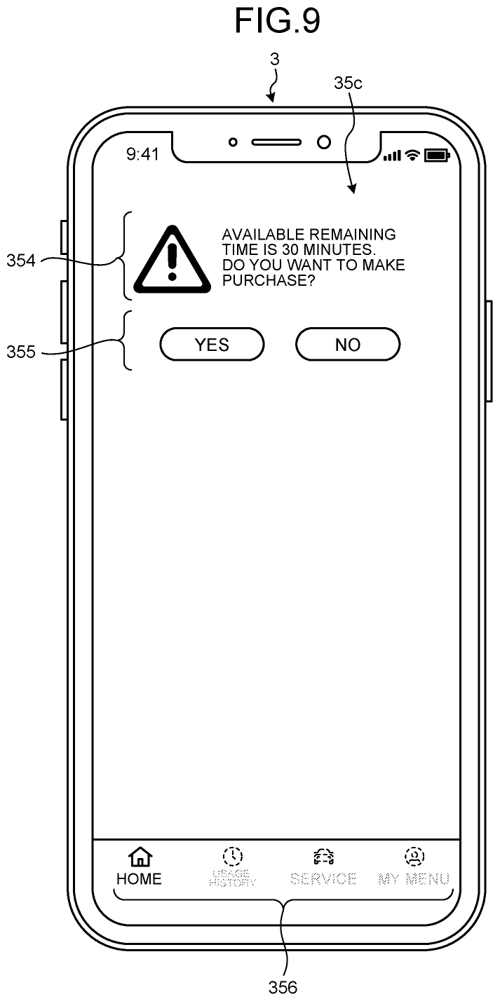

Moreover, the control unit 11 may display a warning message on the operation/display unit 35 by the display control unit 311 in a case where the sum of the settlement amount and the car sharing usage fee would not exceed the balance when the settlement of the settlement amount is executed. FIG. 9 illustrates an example of a warning display screen 35c displayed on the operation/display unit 35 by the display control unit 311. The figure illustrates an example in which the warning message “Available remaining time is 30 minutes. Do you really want to make the purchase?” is displayed in a warning display region 354 and “Yes” or “No” buttons for receiving the selection of whether to extend the car sharing are displayed in a selection region 355. This results in giving the user the knowledge about the remaining available time for the car sharing in a case where the product with a predetermined settlement amount is purchased, making it possible to facilitate selection of whether to purchase the product, leading to enhancement of the convenience of electronic money.

As described above, according to the settlement program, settlement system, and settlement server of the present embodiment, it is possible to enhance the convenience of electronic money used for car sharing. Note that in a settlement server in which a plurality of types of electronic money may be used, it is also allowable to display the information obtained by comparing the usage fee related to the extension of car sharing with the balance of the electronic money registered as the settlement method of car sharing, on the display. This would make it possible to enhance the convenience of electronic money.

According to the present disclosure, it is possible to enhance the convenience of electronic money.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium on which an executable program is recorded, the program causing a processor of a computer to execute
outputting, to a display, information obtained by comparing a charge related to extension of car sharing that provides a rental vehicle with a balance of electronic money registered as a settlement method of the car sharing.

2. The non-transitory computer-readable recording medium according to claim 1, wherein the program causes the processor to execute receiving an extension request for car sharing.

3. The non-transitory computer-readable recording medium according to claim 2, wherein the program causes the processor to execute calculating an extension fee calculated based on the extension request.

4. The non-transitory computer-readable recording medium according to claim 3, wherein the program causes the processor to execute outputting a warning message onto the display in a case where the extension fee exceeds the balance.

5. The non-transitory computer-readable recording medium according to claim 1, wherein the program causes the processor to execute calculating an extendable time within a range of the balance.

6. The non-transitory computer-readable recording medium according to claim 1, wherein the program causes the processor to execute:
determining whether it is able to return a vehicle within a range of the balance; and
outputting a warning message on the display in a case where it is determined that it is not able to return the vehicle within the balance.

7. The non-transitory computer-readable recording medium according to claim 1, wherein the program causes the processor to execute:
receiving a settlement request for a predetermined settlement amount;
determining whether it is able to return a vehicle within a range of the balance for a case where the settlement of the settlement amount is executed; and
outputting a warning message on the display in a case where it is determined that it is not able to return the vehicle within the balance.

8. A settlement system comprising:
a settlement server comprising a first processor comprising hardware; and
a terminal comprising
a second processor comprising hardware, and
a display,
wherein the first processor is configured to control the display to display information obtained by comparing a charge related to extension of car sharing that provides a rental vehicle with a balance of electronic money registered as a settlement method of the car sharing.

9. The settlement system according to claim 8, wherein the first processor is configured to receive an extension request for car sharing.

10. The settlement system according to claim 9, wherein the first processor is configured to calculate an extension fee calculated based on the extension request.

11. The settlement system according to claim 10, wherein the first processor is configured to Control the display to display a warning message in a case where the extension fee exceeds the balance.

12. The settlement system according to claim 8, wherein the first processor is configured to calculate an extendable time within a range of the balance.

13. The settlement system according to claim 8, wherein the first processor is configured to:
determine whether it is able to return a vehicle within a range of the balance; and
control the display to display a warning message in a case where it is determined that it is not able to return the vehicle within the balance.

14. The settlement system according to claim 8, wherein the first processor is configured to:
receive a settlement request for a predetermined settlement amount;
determine whether it is able to return a vehicle within a range of the balance for a case where the settlement of the settlement amount is executed; and
control the display to display a warning message in a case where it is determined that it is not able to return the vehicle within the balance.

15. A settlement server comprising
a processor comprising hardware, the processor being configured to control a display to display information obtained by comparing a charge related to extension of car sharing that provides a rental vehicle with a balance of electronic money registered as a settlement method of the car sharing.

16. The settlement server according to claim 15, wherein the processor is configured to receive an extension request for car sharing.

17. The settlement server according to claim 16, wherein the processor is configured to calculate an extension fee calculated based on the extension request.

18. The settlement server according to claim 17, wherein the processor is configured to control the display to display a warning message in a case where the extension fee exceeds the balance.

19. The settlement server according to claim 15, wherein the processor is configured to:
determine whether it is able to return a vehicle within a range of the balance; and
control the display to display a warning message in a case where it is determined that it is not able to return the vehicle within the balance.

20. The settlement server according to claim 15, wherein the processor is configured to:
receive a settlement request for a predetermined settlement amount;
determine whether it is able to return a vehicle within a range of the balance for a case where the settlement of the settlement amount is executed; and
control the display to display a warning message in a case where it is determined that it is not able to return the vehicle within the balance.
